(19) United States
(12) Patent Application Publication
(10) Pub. No.: US 2026/0166917 A1
(43) Pub. Date: Jun. 18, 2026

(54) WHEEL BEARING FOR PART-TIME FOUR-WHEEL DRIVE VEHICLE

(71) Applicant: ILJIN GLOBAL Co.,Ltd, Seoul (KR)

(72) Inventors: Hee Jae YOON, Seoul (KR); Kyung Jun LEE, Seoul (KR); Hyo Chang SEONG, Seoul (KR); Young Jin KIM, Seoul (KR)

(73) Assignee: ILJIN GLOBAL Co.,Ltd, Seoul (KR)

(21) Appl. No.: 19/417,886

(22) Filed: Dec. 12, 2025

(30) Foreign Application Priority Data
Dec. 13, 2024 (KR) 10-2024-0186408

(51) Int. Cl. B60B 27/00; B60B 27/02

(52) U.S. Cl. CPC B60B 27/0026; B60B 27/0036; B60B 27/02; B60B 2310/54; B60B 2380/12

(57) ABSTRACT

Provided is a wheel bearing for a part-time four-wheel-drive vehicle capable of switching between a two-wheel-drive mode and a four-wheel-drive mode. The wheel bearing includes a wheel hub to which a vehicle wheel is mounted and which rotates together with the vehicle wheel; at least one inner ring mounted to the wheel hub; an outer ring fixedly coupled to a vehicle-body-side member; and a plurality of rolling elements configured to rotatably support the wheel hub and the inner ring relative to the outer ring. An inner circumferential surface of the wheel hub is provided with hub splines extending in an axial direction such that a clutch member is configured to be selectively connected to and disconnected from the hub splines to perform switching between the two-wheel-drive mode and the four-wheel-drive mode. The hub splines of the wheel hub are configured to undergo surface hardening heat treatment.

### CROSS-REFERENCE TO RELATED APPLICATION

This application claims priority to Korean Patent Application No. 10-2024-0186408 filed on Dec. 13, 2024, the entire contents of which are herein incorporated by reference.

### TECHNICAL FIELD

The present disclosure relates to a vehicular wheel bearing for rotatably mounting and supporting a vehicle wheel to a vehicle body, and more particularly, to a wheel bearing for a part-time four-wheel-drive vehicle capable of switching between a two-wheel-drive mode and a four-wheel-drive mode.

### DESCRIPTION OF THE RELATED ART

Referring to FIG. 1, a wheel bearing 10 for a part-time four-wheel-drive vehicle, which is configured to selectively connect and disconnect a drive shaft and the wheel bearing so as to be switchable between a two-wheel-drive mode and a four-wheel-drive mode, is illustratively shown.

The wheel bearing 10 for a part-time four-wheel-drive vehicle may be configured, generally similarly to a conventional wheel bearing, such that a rotating element (for example, a wheel hub 20 and an inner ring 30) that rotates together with a vehicle wheel is connected to a non-rotating element (for example, an outer ring 40) fixed to a vehicle body through a plurality of rolling elements 50, thereby rotatably supporting the vehicle wheel with respect to the vehicle body.

Further, a coupler 60 having splines may be coupled to a vehicle-body-side end portion of the wheel hub 20, such that a drive shaft is selectively connected to or disconnected from the wheel bearing through the coupler 60.

Specifically, when a clutch member 70 that rotates in synchronization with a drive shaft (for example, a constant velocity joint 80) is moved axially outward so that splines formed on an inner circumferential surface of the clutch member 70 are engaged with splines formed on an outer circumferential surface of the coupler 60, the wheel bearing is connected to the drive shaft and receives driving power therefrom. Conversely, when the clutch member 70 is moved axially inward so that the splines formed on the inner circumferential surface of the clutch member 70 are disengaged from the splines formed on the outer circumferential surface of the coupler 60, transmission of driving power between the wheel bearing and the drive shaft is released.

However, in the wheel bearing 10 for a part-time four-wheel-drive vehicle illustrated in FIG. 1, since the coupler 60 configured to engage with the clutch member 70 for switching between the two-wheel-drive mode and the four-wheel-drive mode should be provided on an outer circumferential surface of the wheel hub 20, and splines should be formed on the outer circumferential surface of the wheel hub 20 in the vicinity of a forming portion 22 to allow coupling of the coupler 60, there is a problem in that it is difficult to secure sufficient rigidity at a spline coupling portion in the vicinity of the forming portion 22.

### DISCLOSURE OF THE INVENTION

### Technical Goals

The present disclosure has been made to address the above-described matters, and the present disclosure is for the purpose of providing a wheel bearing for a part-time four-wheel-drive vehicle capable of switching between a two-wheel-drive mode and a four-wheel-drive mode, in which splines configured to engage with a clutch member are directly provided on an inner circumferential surface of a wheel hub, and a heat-treated hardened portion is formed on the splines, thereby ensuring sufficient rigidity for transmission of driving power.

### Technical Solutions

Representative configurations of the present disclosure to achieve the above-described purpose are as follows.

According to an embodiment of the present disclosure, a wheel bearing for a part-time four-wheel-drive vehicle capable of switching between a two-wheel-drive mode and a four-wheel-drive mode may be provided. The wheel bearing according to an embodiment of the present disclosure may comprise: a wheel hub to which a vehicle wheel is mounted and which rotates together with the vehicle wheel; at least one inner ring mounted to the wheel hub; an outer ring fixedly coupled to a vehicle-body-side member; and a plurality of rolling elements configured to rotatably support the wheel hub and the inner ring relative to the outer ring. According to an embodiment of the present disclosure, an inner circumferential surface of the wheel hub may be provided with hub splines extending in an axial direction such that a clutch member is configured to be selectively connected to and disconnected from the hub splines to perform switching between the two-wheel-drive mode and the four-wheel-drive mode. According to an embodiment of the present disclosure, the hub splines of the wheel hub may be configured to undergo surface hardening heat treatment.

According to an embodiment of the present disclosure, an outer circumferential surface of the wheel hub may be configured to undergo surface hardening heat treatment in a region including an inner-ring mounting portion to which the inner ring is mounted.

According to an embodiment of the present disclosure, a hub-spline heat-treated hardened portion provided on the hub splines of the wheel hub may be configured to be positioned within an axial range of a hub outer-surface heat-treated hardened portion provided on the outer circumferential surface of the wheel hub.

According to an embodiment of the present disclosure, the hub-spline heat-treated hardened portion provided on the hub splines of the wheel hub may be formed so as not to overlap with the hub outer-surface heat-treated hardened portion provided on the outer circumferential surface of the wheel hub.

According to an embodiment of the present disclosure, the hub-spline heat-treated hardened portion and the hub outer-surface heat-treated hardened portion may be positioned to be spaced apart from an axially inner end of the wheel hub by 10 mm or more in an axial direction.

According to an embodiment of the present disclosure, an axial length of the hub splines of the wheel hub may be formed within a range of 0.1 times to 0.25 times an inner circumferential diameter of the hub splines.

According to an embodiment of the present disclosure, the axial length of the hub splines 240 may be formed within a range of 5 mm to 15 mm.

According to an embodiment of the present disclosure, the wheel hub may comprise a protrusion protruding radially inward from the inner circumferential surface thereof, and the hub splines may be formed on an inner circumferential surface of the protrusion.

According to an embodiment of the present disclosure, a rolling bearing assembly may be provided on the inner circumferential surface of the wheel hub at a position axially outward relative to the protrusion.

According to an embodiment of the present disclosure, the rolling bearing assembly may comprise an outer-row bearing 262 and an inner-row bearing 264 arranged to be spaced apart from each other in an axial direction.

According to an embodiment of the present disclosure, the outer-row bearing of the rolling bearing assembly may be positioned axially outward of a wheel-mounting flange of the wheel hub, and the inner-row bearing of the rolling bearing assembly may be positioned axially inward of the wheel-mounting flange of the wheel hub.

According to an embodiment of the present disclosure, the rolling bearing assembly may further comprise: an outer sleeve disposed between an outer ring of the outer-row bearing and an outer ring of the inner-row bearing; and an inner sleeve positioned radially inward relative to the outer sleeve.

According to an embodiment of the present disclosure, an inner ring of the outer-row bearing and an inner ring of the inner-row bearing may be mounted to an outer circumferential surface of the inner sleeve in a press-fitted manner.

According to an embodiment of the present disclosure, the outer circumferential surface of the inner sleeve may be provided with a stopper protruding radially outward, and the stopper may be positioned between the inner ring of the outer-row bearing and the inner ring of the inner-row bearing.

According to an embodiment of the present disclosure, the inner sleeve may be formed as a tubular structure having a central through-hole, and a central axis of a constant velocity joint may be inserted into and mounted in the central through-hole of the inner sleeve.

In addition, the vehicular wheel bearing according to the present disclosure may further comprise other additional components to the extent that it does not impair the technical idea of the present disclosure.

### Effects

According to an embodiment of the present disclosure, the wheel bearing for a part-time four-wheel-drive vehicle is configured such that splines (hub splines) for engagement with a clutch member are directly formed on an inboard-side inner circumferential surface of a wheel hub. Accordingly, switching between a two-wheel-drive mode and a four-wheel-drive mode can be achieved without coupling a separate coupler member to the wheel hub.

In addition, according to an embodiment of the present disclosure, the wheel bearing for a part-time four-wheel-drive vehicle is configured such that a hardening heat treatment is performed on the splines (hub splines) provided on the inner circumferential surface of the wheel hub. As a result, sufficient rigidity can be secured for the splines (hub splines) that engage with the clutch member to transmit driving power.

Further, according to an embodiment of the present disclosure, the splines (hub splines) provided on the inner circumferential surface of the wheel hub and subjected to the hardening heat treatment are positioned to be spaced apart from an axially inner end of the wheel hub by a predetermined distance. With this configuration, it is possible to prevent deformation of the splines (hub splines) or interference caused by the heat-treated hardened portion during a process of plastically deforming the axially inner end of the wheel hub to form a forming portion.

Furthermore, according to an embodiment of the present disclosure, an axial length of the splines (hub splines) provided on the inner circumferential surface of the wheel hub and subjected to the hardening heat treatment is controlled within a predetermined range. Accordingly, while sufficient strength for transmission of driving power is provided to the splines (hub splines), it is possible to prevent deformation occurring during the hardening heat treatment process that could otherwise hinder spline engagement.

Moreover, according to an embodiment of the present disclosure, a rolling bearing assembly is provided on an axially outer inner circumferential surface of the wheel hub, such that the wheel hub can be stably rollingly supported and operated with respect to a constant velocity joint or the like by the rolling bearing assembly.

### BRIEF DESCRIPTION OF THE DRAWINGS

FIG. 1 illustratively shows an example of a wheel bearing for a part-time four-wheel-drive vehicle.

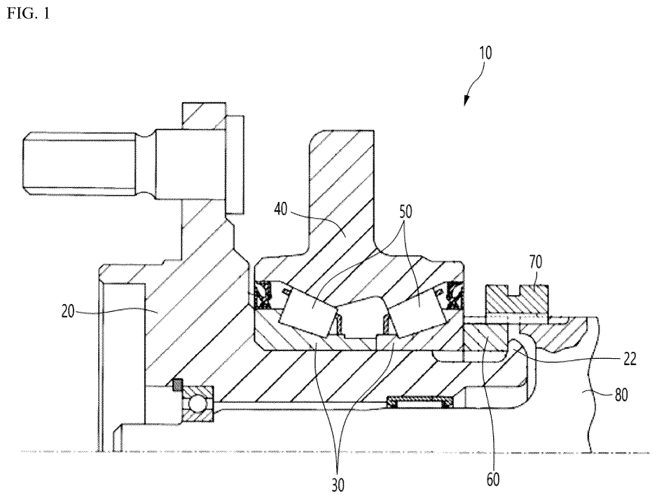

FIG. 2 is a partially cutaway perspective view illustratively showing an overall structure of a vehicular wheel bearing according to an embodiment of the present disclosure.

FIG. 3 is a cross-sectional view illustratively showing a structure of a vehicular wheel bearing according to an embodiment of the present disclosure.

FIG. 4 is a view illustratively showing a structure of an axially inner end portion of a vehicular wheel bearing according to an embodiment of the present disclosure.

FIG. 5 is a view illustratively showing a structure of a clutch member applicable to a vehicular wheel bearing according to an embodiment of the present disclosure.

### DETAILED DESCRIPTION

Example embodiments of the present disclosure described herein are exemplified for the purpose of describing the technical spirit of the present disclosure. The scope of the claims according to the present disclosure is not limited to the example embodiments described below or to detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising,” “including,” “having,” and the like used herein should be construed as open-ended terms encompassing the possibility of including other example embodiments.

The term “axial direction” used herein may be defined as a direction extending along a rotational central axis of a wheel bearing, wherein “axially inner” refers to a direction toward a vehicle body, and “axially outer” refers to a direction toward a wheel. The term “radial direction” used herein may be defined as a direction perpendicular to the axial direction and away from the rotational central axis or approaching the rotational central axis. The term “circumferential direction” used herein may be defined as a direction rotating about the axial direction described above.

Unless the phrase or sentence clearly indicates otherwise, the expression “a constituent element extends in the axial direction or the radial direction” used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, preferred embodiments of the present disclosure will be described in detail with reference to the accompanying drawings to such an extent that a person having ordinary skill in the art to which the present disclosure pertains can readily practice the present disclosure. In the accompanying drawings, the same reference numerals are assigned to the same or corresponding components. Furthermore, in the following descriptions of the example embodiments, duplicate description(s) of the same or corresponding constituent elements may be omitted. However, even if description(s) of a specific component is omitted in the following description, this is not intended to mean that such component is excluded from the corresponding embodiment.

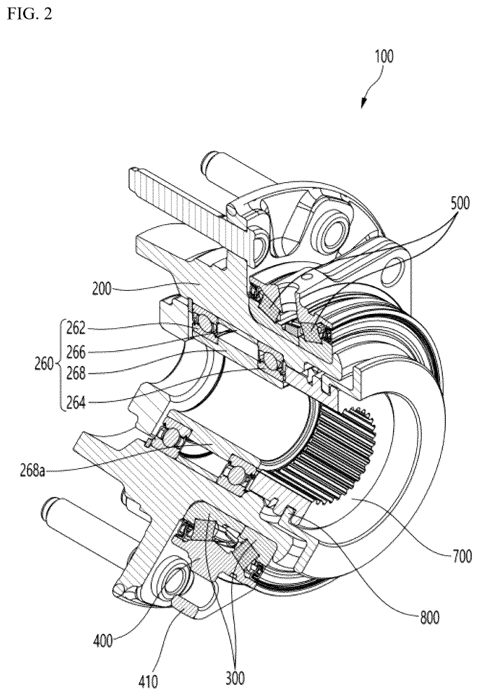

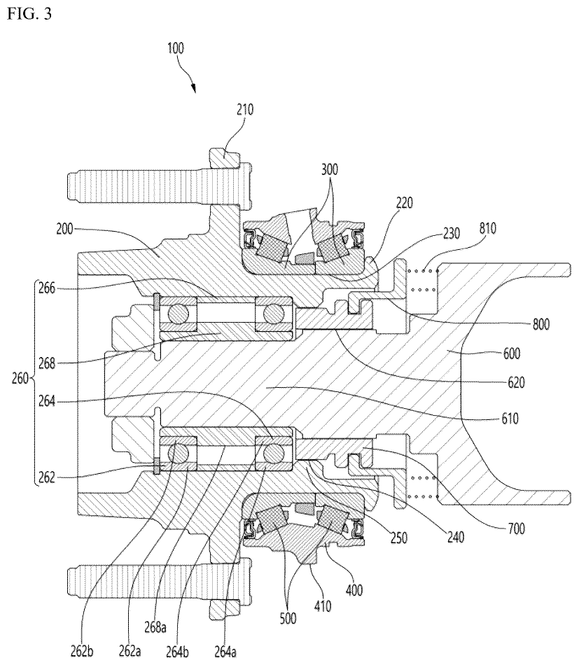

Referring to FIGS. 2 to 5, a vehicular wheel bearing 100 according to an embodiment of the present disclosure is illustratively shown. As shown in the drawings, the vehicular wheel bearing 100 according to an embodiment of the present disclosure may be configured as a wheel bearing for a part-time four-wheel-drive vehicle capable of switching between a two-wheel-drive mode and a four-wheel-drive mode.

According to an embodiment of the present disclosure, the vehicular wheel bearing 100 may comprise: a wheel hub 200 to which a vehicle wheel is mounted and which rotates together with the vehicle wheel; at least one inner ring 300 mounted on the wheel hub 200; an outer ring 400 fixedly coupled to a vehicle-body-side member; and a plurality of rolling elements 500 configured to rotatably support the wheel hub 200 and the inner ring 300 relative to the outer ring 400.

According to an embodiment of the present disclosure, the wheel hub 200 may be formed in a substantially cylindrical structure extending along an axial direction, and a wheel-mounting flange 210 (hub flange) may be provided on an outer circumferential surface on one side of the wheel hub 200. The wheel-mounting flange 210 may be formed to extend radially outward from the outer circumferential surface of the wheel hub 200 and may be used to mount a vehicle wheel to the wheel hub 200 using hub bolts or the like. Meanwhile, at least one inner ring 300 may be coupled to a vehicle-body-side end portion of the wheel hub 200, and the inner ring(s) 300 may be fixed on the wheel hub 200 in a state in which a predetermined preload is applied by a forming portion 220 formed by plastically deforming the vehicle-body-side end portion of the wheel hub 200 radially outward.

According to an embodiment of the present disclosure, one or more inner rings 300 may be mounted on the outer circumferential surface of the wheel hub 200, and an outer circumferential surface of the inner ring 300 may be formed with a raceway surface (an inner raceway surface) for rolling elements so as to support the rolling elements 500 from a radially inner side. For example, the inner ring 300 may be press-fitted and mounted to an inner-ring mounting portion 230 provided in the vicinity of the vehicle-body-side end portion of the wheel hub 200.

According to an embodiment of the present disclosure, the outer ring 400 may comprise, on an outer circumferential surface thereof, a vehicle-body-side mounting flange 410 used to mount the wheel bearing 100 to a vehicle-body-side member (for example, a chassis member such as a knuckle), and may comprise, on an inner circumferential surface thereof, raceway surfaces that contact the rolling elements 500. The raceway surfaces (outer raceway surfaces) formed on the inner circumferential surface of the outer ring 400 may cooperate with raceway surfaces (inner raceway surfaces) formed on the wheel hub 200 and/or the inner ring 300 to receive and support the rolling elements 500, which are rolling members, between the raceway surfaces.

According to an embodiment of the present disclosure, the rolling elements 500 may be interposed between a rotating element of the wheel bearing 100 (for example, the wheel hub 200 and/or the inner ring 300) and a non-rotating element (for example, the outer ring 400), and may perform a function of rotatably supporting the rotating element of the wheel bearing 100 relative to the non-rotating element of the wheel bearing 100.

However, the above-described configurations of the vehicular wheel bearing 100 according to an embodiment of the present disclosure are not necessarily limited to the structures shown in the drawings, and may be variously modified into different structures applicable to vehicular wheel bearings.

For example, in the embodiment shown in the drawings, two inner rings 300 are mounted on an outer circumferential surface of the wheel hub 200 to support the rolling elements 500. However, the vehicular wheel bearing 100 according to an embodiment of the present disclosure may be implemented in other modified structures, such as a structure in which one raceway surface for supporting the rolling elements is directly formed on a portion of the outer circumferential surface of the wheel hub 200.

Further, in the embodiment shown in the drawings, the rolling elements 500 configured to rotatably support the rotating element (for example, the wheel hub 200 and/or the inner ring 300) of the wheel bearing 100 relative to the non-rotating element (for example, the outer ring 400) of the wheel bearing 100 are formed in a tapered roller shape. However, the rolling elements 500 may alternatively be formed in other shapes of rolling elements, such as spherical balls.

According to an embodiment of the present disclosure, the wheel hub 200 may be formed in a structure having a central through-hole, and hub splines 240 extending in an axial direction may be provided on an inner circumferential surface of the wheel hub 200 so as to engage with a clutch member 700 for switching between a two-wheel-drive mode and a four-wheel-drive mode.

According to an embodiment of the present disclosure, the wheel hub 200 may comprise a protrusion 250 protruding radially inward from the inner circumferential surface thereof, and the hub splines 240 may be formed on an inner circumferential surface of the protrusion 250.

According to an embodiment of the present disclosure, the hub splines 240 may be configured to be spaced apart from an axially inner end of the wheel hub 200 by a predetermined distance, and may be configured to be spaced apart from the axially inner end of the wheel hub 200 by 10 mm or more so as not to interfere with formation of a forming portion 220 at the axially inner end portion of the wheel hub 200.

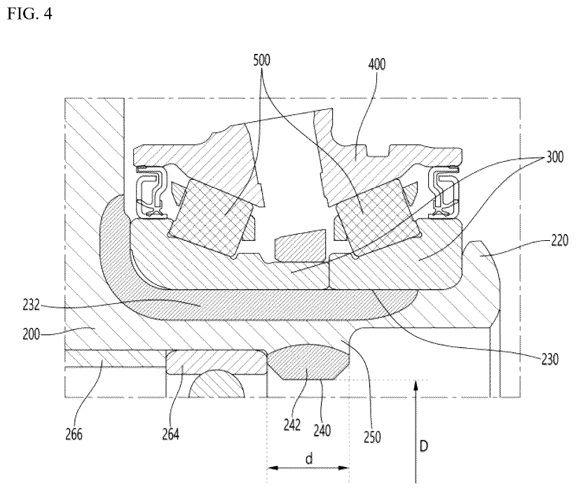

According to an embodiment of the present disclosure, the hub splines 240 may be configured to undergo surface hardening heat treatment so as to secure rigidity required for stable transmission of driving power (see a hub-spline heat-treated hardened portion 242 shown in FIG. 4).

According to an embodiment of the present disclosure, the hub splines 240 may be formed to have an axial length d within a predetermined range, and for example, the axial length d of the hub splines 240 may be formed within a range of 0.1 times to 0.25 times an inner circumferential diameter D of the hub splines 240.

If an axial length d of the hub splines 240 is formed to be excessively small, it may be difficult to sufficiently ensure stable transmission of driving power through spline engagement. Conversely, if the axial length d of the hub splines 240 is formed to be excessively large, significant thermal deformation may occur in the hub splines 240 during a surface hardening heat treatment process performed on the hub splines 240, thereby making it difficult to ensure stable spline engagement. Accordingly, it may be preferable that the axial length d of the hub splines 240 be controlled within the above-described range.

According to an embodiment of the present disclosure, an axial length d of a heat-treated hardened portion provided on the hub splines 240 of the wheel hub 200 (hub-spline heat-treated hardened portion 242) may preferably be formed within a range of 5 mm to 15 mm.

According to an embodiment of the present disclosure, the wheel hub 200 may be configured such that a surface hardening heat treatment is also performed on an outer circumferential surface thereof (see a hub outer-surface heat-treated hardened portion 232 shown in FIG. 4).

According to an embodiment of the present disclosure, the heat-treated hardened portion provided on the outer circumferential surface of the wheel hub 200 (hub outer-surface heat-treated hardened portion 232) may be configured to at least partially include an inner-ring mounting portion 230 to which the inner ring 300 is press-fitted and mounted.

According to an embodiment of the present disclosure, a heat-treated hardened portion provided on an outer circumferential surface of the wheel hub 200 (hub outer-surface heat-treated hardened portion 232) may be formed to extend from a base portion of the wheel-mounting flange 210 to an intermediate portion of the inner-ring mounting portion 230 (that is, to a position spaced apart by a predetermined distance from an axially inner end of the inner-ring mounting portion 230), as shown in FIG. 4.

According to an embodiment of the present disclosure, the heat-treated hardened portion provided on the hub splines 240 of the wheel hub 200 (hub-spline heat-treated hardened portion 242) and the heat-treated hardened portion provided on the outer circumferential surface of the wheel hub 200 (hub outer-surface heat-treated hardened portion 232) may each be formed to have a depth of 5 mm or less, and the two heat-treated hardened portions may be formed so as not to overlap with each other.

According to an embodiment of the present disclosure, the heat-treated hardened portion provided on the hub splines 240 of the wheel hub 200 (hub-spline heat-treated hardened portion 242) may be configured to be positioned within an axial range of the heat-treated hardened portion provided on the outer circumferential surface of the wheel hub 200 (hub outer-surface heat-treated hardened portion 232).

According to an embodiment of the present disclosure, the heat-treated hardened portion provided on the hub splines 240 of the wheel hub 200 (hub-spline heat-treated hardened portion 242) and the heat-treated hardened portion provided on the outer circumferential surface of the wheel hub 200 (hub outer-surface heat-treated hardened portion 232) may be configured to be positioned at locations spaced apart from an axially inner end of the wheel hub 200 by a predetermined distance (for example, by a distance of 10 mm or more).

According to an embodiment of the present disclosure, a rolling bearing assembly 260 may be provided on an inner circumferential surface of the wheel hub 200 so as to assist smooth relative rotation between the wheel hub 200 and a constant velocity joint 600.

According to an embodiment of the present disclosure, the rolling bearing assembly 260 may be disposed on the inner circumferential surface of the wheel hub 200 at a position axially outward relative to a protrusion 250 on which the hub splines 240 are formed.

According to an embodiment of the present disclosure, the rolling bearing assembly 260 may comprise two rows of rolling bearings (e.g., an outer-row bearing 262 positioned axially outward and an inner-row bearing 264 positioned axially inward) arranged to be spaced apart from each other in an axial direction.

According to an embodiment of the present disclosure, the rolling bearing assembly 260 may further comprise an outer sleeve 266 positioned radially outward and an inner sleeve 268 positioned radially inward.

According to an embodiment of the present disclosure, the outer sleeve 266 may be positioned between an outer ring 262a of the outer-row bearing 262 and an outer ring 264a of the inner-row bearing 264, and an inner ring 262b of the outer-row bearing 262 and an inner ring 264b of the inner-row bearing 264 may be press-fitted and mounted onto an outer circumferential surface of the inner sleeve 268.

According to an embodiment of the present disclosure, the inner sleeve 268 may comprise, on an outer circumferential surface thereof, a stopper 268a protruding radially outward, and the stopper 268a of the inner sleeve 268 may be configured to be positioned between an inner ring 262b of the outer-row bearing 262 and an inner ring 264b of the inner-row bearing 264.

According to an embodiment of the present disclosure, the inner sleeve 268 may be formed in a tubular structure having a central through-hole, and a central axis 610 of a constant velocity joint 600 may be inserted into and mounted in the central through-hole of the inner sleeve 268.

According to an embodiment of the present disclosure, for more stable relative rotational support between the wheel hub 200 and the constant velocity joint 600, the outer-row bearing 262 may be positioned axially outward relative to the wheel-mounting flange 210 of the wheel hub 200, and the inner-row bearing 264 may be positioned axially inward relative to the wheel-mounting flange 210.

According to an embodiment of the present disclosure, a clutch member 700 may be selectively engaged with the hub splines 240 provided on the inner circumferential surface of the wheel hub 200 so as to selectively transmit or block driving power.

According to an embodiment of the present disclosure, the clutch member 700 may be configured to selectively engage with the hub splines 240 of the wheel hub 200 while moving in an axial direction, in a manner similar to that of conventional wheel bearings for a part-time four-wheel-drive vehicle.

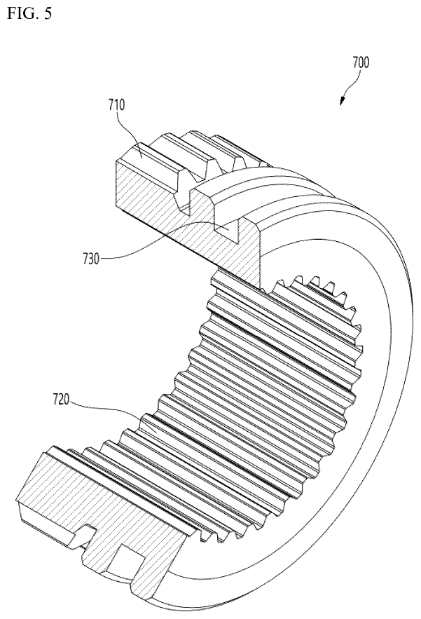

Referring to FIG. 5, an example of a clutch member 700 that may be used in the wheel bearing 100 for a part-time four-wheel-drive vehicle according to an embodiment of the present disclosure is illustratively shown.

According to an embodiment of the present disclosure, the clutch member 700 may comprise hub-engagement splines 710 provided on an outer circumferential surface thereof and configured to engage with the hub splines 240 of the wheel hub 200, and may further comprise constant-velocity-joint engagement splines 720 provided on an inner circumferential surface thereof and configured to engage with constant velocity joint splines 620.

According to an embodiment of the present disclosure, the clutch member 700 may comprise an engagement groove 730 on one side thereof, and an operating member 800 of an actuator (not shown) may be engaged with the engagement groove 730 so as to implement axial movement of the clutch member 700.

For example, when an actuator is actuated, an operating member 800 may receive a force pulling the operating member 800 axially inward, thereby disengaging the clutch member 700 from the hub splines 240, so that the vehicle can travel in a two-wheel-drive mode. When operation of the actuator is stopped, the operating member 800 may return to its original position by an elastic force of an elastic member 810, whereby the clutch member 700 is engaged with the hub splines 240 and the vehicle can travel in a four-wheel-drive mode.

However, the clutch member 700 shown in the drawings represents only an exemplary embodiment applicable to the wheel bearing 100 for a part-time four-wheel-drive vehicle according to an embodiment of the present disclosure, and the clutch member 700 is not limited to the structure shown in the drawings. Rather, the clutch member 700 may be variously modified into different structures applicable to vehicular wheel bearings.

Although the present disclosure has been described above with reference to specific matters such as particular constituent elements and limited embodiments, these embodiments are provided only to assist in a more comprehensive understanding of the present disclosure, and the present disclosure is not limited thereto. Rather, various modifications and variations may be made from such descriptions by a person having ordinary skill in the art to which the present disclosure pertains.

Accordingly, the spirit of the present disclosure should not be construed as being limited to the embodiments described above, and not only the claims set forth below but also all modifications and variations that are equivalent or substantially equivalent to the scope of the claims should be understood as falling within the scope of the spirit of the present disclosure.

### EXPLANATION OF REFERENCE NUMERALS

100: vehicular wheel bearing
200: wheel hub
210: wheel-mounting flange
220: forming portion
230: inner-ring mounting portion
232: hub outer-surface heat-treated hardened portion
240: hub splines
242: hub-spline heat-treated hardened portion
250: protrusion
260: rolling bearing assembly
262: outer-row bearing
264: inner-row bearing
266: outer sleeve
268: inner sleeve
300: inner ring
400: outer ring
410: vehicle-body-side mounting flange
500: rolling element
600: constant velocity joint
610: central axis of constant velocity joint
620: constant-velocity-joint splines
700: clutch member
710: hub-engagement splines
720: constant-velocity-joint engagement splines
730: engagement groove
800: operating member
810: elastic member

What is claimed is:

1. A wheel bearing (100) for a part-time four-wheel-drive vehicle capable of switching between a two-wheel-drive mode and a four-wheel-drive mode, comprising:
a wheel hub (200) to which a vehicle wheel is mounted and which rotates together with the vehicle wheel;
at least one inner ring (300) mounted to the wheel hub (200);
an outer ring (400) fixedly coupled to a vehicle-body-side member; and
a plurality of rolling elements (500) configured to rotatably support the wheel hub (200) and the inner ring (300) relative to the outer ring (400),
wherein an inner circumferential surface of the wheel hub (200) is provided with hub splines (240) extending in an axial direction such that a clutch member (700) is configured to be selectively connected to and disconnected from the hub splines (240) to perform switching between the two-wheel-drive mode and the four-wheel-drive mode, and
wherein the hub splines (240) of the wheel hub (200) are configured to undergo surface hardening heat treatment.

2. The wheel bearing according to claim 1, wherein an outer circumferential surface of the wheel hub (200) is configured to undergo surface hardening heat treatment in a region including an inner-ring mounting portion (230) to which the inner ring (300) is mounted.

3. The wheel bearing according to claim 2, wherein a hub-spline heat-treated hardened portion (242) provided on the hub splines (240) of the wheel hub (200) is configured to be positioned within an axial range of a hub outer-surface heat-treated hardened portion (232) provided on the outer circumferential surface of the wheel hub

(200) .

4. The wheel bearing according to claim 3, wherein the hub-spline heat-treated hardened portion (242) provided on the hub splines (240) of the wheel hub (200) is formed so as not to overlap with the hub outer-surface heat-treated hardened portion (232) provided on the outer circumferential surface of the wheel hub (200).

5. The wheel bearing according to claim 4, wherein the hub-spline heat-treated hardened portion (242) and the hub outer-surface heat-treated hardened portion (232) are positioned to be spaced apart from an axially inner end of the wheel hub (200) by 10 mm or more in an axial direction.

6. The wheel bearing according to claim 1, wherein an axial length d of the hub splines (240) of the wheel hub (200) is formed within a range of 0.1 times to 0.25 times an inner circumferential diameter D of the hub splines (240).

7. The wheel bearing according to claim 6, wherein the axial length d of the hub splines (240) is formed within a range of 5 mm to 15 mm.

8. The wheel bearing according to claim 1, wherein the wheel hub (200) comprises a protrusion (250) protruding radially inward from the inner circumferential surface thereof, and
wherein the hub splines (240) are formed on an inner circumferential surface of the protrusion (250).

9. The wheel bearing according to claim 1, wherein a rolling bearing assembly (260) is provided on the inner circumferential surface of the wheel hub (200) at a position axially outward relative to a protrusion (250).

10. The wheel bearing according to claim 9, wherein the rolling bearing assembly (260) comprises an outer-row bearing (262) and an inner-row bearing (264) arranged to be spaced apart from each other in an axial direction.

11. The wheel bearing according to claim 10, wherein the outer-row bearing (262) of the rolling bearing assembly (260) is positioned axially outward of a wheel-mounting flange (210) of the wheel hub (200), and
wherein the inner-row bearing (264) of the rolling bearing assembly (260) is positioned axially inward of the wheel-mounting flange (210) of the wheel hub (200).

12. The wheel bearing according to claim 11, wherein the rolling bearing assembly (260) further comprises:
an outer sleeve (266) disposed between an outer ring (262a) of the outer-row bearing (262) and an outer ring (264a) of the inner-row bearing (264); and
an inner sleeve (268) positioned radially inward relative to the outer sleeve (266).

13. The wheel bearing according to claim 12, wherein an inner ring (262b) of the outer-row bearing (262) and an inner ring (264b) of the inner-row bearing (264) are mounted to an outer circumferential surface of the inner sleeve (268) in a press-fitted manner.

14. The wheel bearing according to claim 13, wherein the outer circumferential surface of the inner sleeve (268) is provided with a stopper (268a) protruding radially outward, and
wherein the stopper (268a) is positioned between the inner ring (262b) of the outer-row bearing (262) and the inner ring (264b) of the inner-row bearing (264).

15. The wheel bearing according to claim 14, wherein the inner sleeve (268) is formed as a tubular structure having a central through-hole, and
wherein a central axis (610) of a constant velocity joint (600) is inserted into and mounted in the central through-hole of the inner sleeve (268).
